(19) United States
(12) Patent Application Publication
(10) Pub. No.: US 2020/0250004 A1
(43) Pub. Date: Aug. 6, 2020

(54) INFORMATION PROCESSING DEVICE AND STORAGE MEDIUM

(71) Applicant: FUJITSU LIMITED, Kawasaki-shi (JP)

(72) Inventors: MASANORI FURUYA, Kawasaki (JP); Kensuke Shiozawa, Kawasaki (JP)

(73) Assignee: FUJITSU LIMITED, Kawasaki-shi (JP)

(21) Appl. No.: 16/774,025

(22) Filed: Jan. 28, 2020

(30) Foreign Application Priority Data
Feb. 4, 2019 (JP) 2019-017984

(51) Int. Cl. G06F 9/50; G06F 13/18

(52) U.S. Cl. CPC G06F 9/5044; G06F 13/18; G06F 9/5038; G06F 9/5016

(57) ABSTRACT

An information processing device includes a processor, and an input/output device configured to input/output data from/to the processor, wherein the processor is configured to repeatedly execute a processing loop including execution control processing of checking an event from the input/output device, and when an event is detected, executing processing depending on the event detected, measure, when the information processing device is in an idle state, a first count value indicating an execution frequency of the processing loop per unit time, measure, when the information processing device is in an execution state in which the information processing device executes given processing including input/output processing with the input/output device, a second count value indicating the execution frequency of the processing loop per the unit time, and calculate, based on the first count value and the second count value, an indicator indicating a utilization rate of the processor.

### CROSS-REFERENCE TO RELATED APPLICATION

This application is based upon and claims the benefit of priority of the prior Japanese Patent Application No. 2019-17984, filed on Feb. 4, 2019, the entire contents of which are incorporated herein by reference.

### FIELD

The embodiments discussed herein are related to an information processing device and an information processing program.

### BACKGROUND

As one of indicators indicating the states of computers, the utilization rate (also called “use rate” or “busy rate”) of a processor in a computer has generally been utilized. As a method of measuring processor utilization rates, for example, a method of measuring utilization rates based on the execution time of idle tasks (or idle threads) has been known.

For example, the following method that uses sample values obtained through sampling of a program loop frequency has also been proposed. In this method, the average value of a plurality of sample values is obtained, and a processor utilization rate is calculated based on a ratio between unit time and production time obtained through subtraction of the product of the average value of the sample values and loop execution time from the unit time.

Meanwhile, in recent years, as mechanisms that receive data from hardware such as communication interfaces, poll mode drivers (PMDs) have attracted attention. A PMD monitors a reception event from hardware by periodic polling, thereby being capable of executing processing of receiving data from the hardware without interruptions and context switches.

For example, as the related arts, Japanese Laid-open Patent Publication No. 2004-264954 and Japanese Laid-open Patent Publication No. 7-006062 are disclosed.

### SUMMARY

According to an aspect of the embodiment, an information processing device includes a processor, and an input/output device configured to input/output data from/to the processor, wherein the processor is configured to repeatedly execute a processing loop including execution control processing of checking an event from the input/output device, and when an event is detected, executing processing depending on the event detected, measure, when the information processing device is in an idle state, a first count value indicating an execution frequency of the processing loop per unit time, measure, when the information processing device is in an execution state in which the information processing device executes given processing including input/output processing with the input/output device, a second count value indicating the execution frequency of the processing loop per the unit time, and calculate, based on the first count value and the second count value, an indicator indicating a utilization rate of the processor.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example and a processing example of an information processing device according to a first embodiment;

FIG. 2 is a diagram illustrating a configuration example of a storage system according to a second embodiment;

FIG. 3 is a diagram illustrating a hardware configuration example of a storage control device;

FIG. 4 is a block diagram illustrating a configuration example of a processing function of a storage control device;

FIGS. 5A and 5B are diagrams illustrating a comparative example in terms of task and hardware event processing;

FIG. 6 is a diagram illustrating an example of the task and hardware event processing in a case where a PMD is used;

FIG. 7 is a diagram illustrating an example of a busy rate calculation method;

FIG. 8 is a diagram illustrating an example of processing included in a scheduler loop;

FIG. 9 is a diagram illustrating processing time allocation per unit time when a performance limit is reached;

FIG. 10 is a diagram illustrating processing time allocation in execution time of one scheduler loop;

FIG. 11 is a flowchart illustrating an example of processing by a storage control device after the storage control device has started (device start processing);

FIG. 12 is a flowchart illustrating an example of scheduler loop processing;

FIG. 13 is a flowchart illustrating an example of processing by a poller;

FIG. 14 is a diagram illustrating load balancing; and

FIG. 15 is a flowchart illustrating an example of busy rate calculation processing.

### DESCRIPTION OF EMBODIMENTS

In processing using PMDs, polling for checking reception events is repeatedly executed irrespective of whether or not there is a reception event from hardware. Thus, no idle task exists, which means that it is difficult to measure processor utilization rates based on the execution time of idle tasks.

According to one aspect, it is an object of the present invention to provide an information processing device and an information processing program capable of measuring processor utilization rates without using the execution time of idle tasks.

Embodiments of the present invention are now described with reference to the drawings.

### First Embodiment

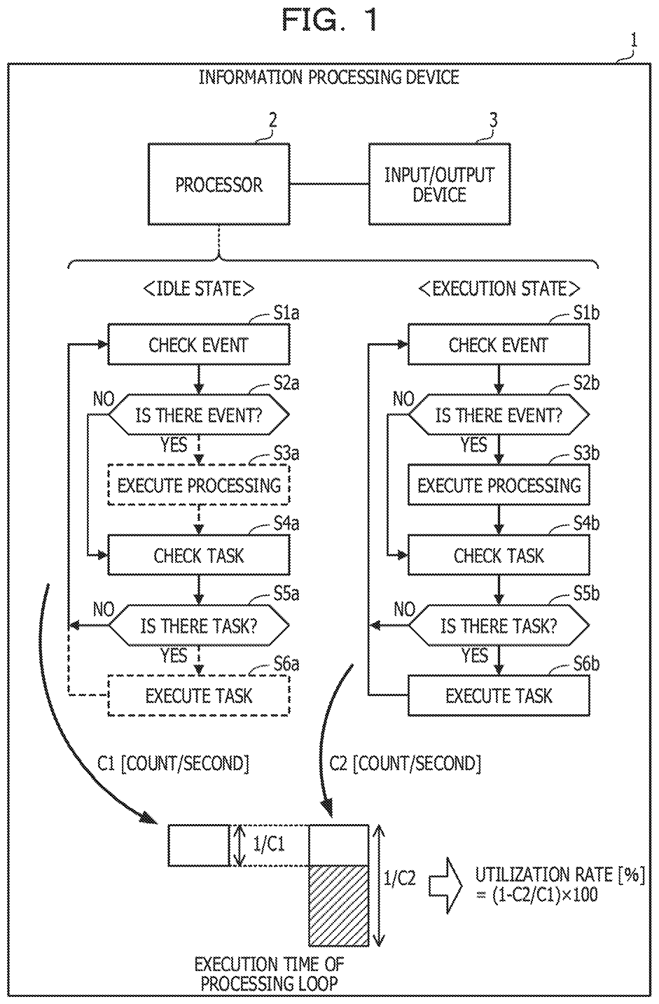

FIG. 1 is a diagram illustrating a configuration example and a processing example of an information processing device according to a first embodiment. An information processing device 1 includes a processor 2 and an input/output device 3. The processor 2 is, for example, a central processing unit (CPU). The processor 2 may be a CPU core in a CPU. The input/output device 3 is a device configured to input/output data from/to the processor 2. The input/output device 3 may be, for example, a communication interface for communication with external devices, a memory device mounted on the information processing device 1, or a processing circuit mounted on the information processing device 1 and configured to process data output from the processor 2, thereby making a response.

In the information processing device 1, the processor 2 checks events from the input/output device 3, and when detecting an event, repeatedly executes a processing loop including execution control processing of executing processing depending on the detected event. In the flowchart of FIG. 1, an event check corresponds to Steps S1a and S1b, a determination on whether an event has been detected corresponds to Steps S2a and S2b, and execution of processing depending on a detected event corresponds to Steps S3a and S3b.

Examples of the event include completion events indicating that the input/output device 3 has completed execution of any processing. In this case, when detecting a completion event, the processor 2 executes, as processing depending on the completion event, for example, processing for acquiring a message indicating processing completion from the input/output device 3. Events are checked by polling, for example. For example, when the input/output device 3 completes processing, an entry indicating the completion is registered in a completion queue. In the event check processing by the processor 2, polling for a completion queue is performed, and when an entry has been acquired, processing depending on an event corresponding to the entry is executed.

The processing loop may further include task control processing of checking tasks, and when an executable task is detected, executing the task in question. In the flowchart of FIG. 1, a task check corresponds to Steps S4a and S4b, a determination on whether an executable task has been detected corresponds to Steps S5a and S5b, and execution of a detected task corresponds to Steps S6a and S6b. The “task” occurs when given processing including the input/output processing with the input/output device 3 is executed.

Incidentally, the event check processing as described above is executed without exception irrespective of whether or not an event is detected. For example, even when no event has been detected, processing of a dummy such as an idle task is not executed. Thus, it is difficult for the information processing device 1 to measure the utilization rate of the processor 2 by measuring the execution time of an idle task.

Accordingly, the information processing device 1 measures the utilization rate of the processor 2 as follows. First, the processor 2 measures, when the information processing device 1 is in an idle state, a count value C1 indicating the execution frequency of the processing loop per unit time. In FIG. 1, the unit time is one second, and a unit of the count value C1 in this case is “count/second.” The idle state is a state in which the above-mentioned given processing including the input/output processing with the input/output device 3 is not executed by the processor 2. Thus, in the idle state, neither events from the input/output device 3 nor tasks occur. Thus, as illustrated in the left-side flowchart of FIG. 1, “No” is determined in both the determinations in Steps S2a and S5a, with the result that neither the execution of processing depending on an event (Step S3a) nor the execution of a task (Step S6a) is performed.

Next, the processor 2 measures, when the information processing device 1 is in an execution state in which the information processing device 1 executes the above-mentioned given processing, a count value C2 indicating the execution frequency of the processing loop per unit time. In the execution state, events from the input/output device 3 may occur. Tasks may also occur. Thus, as illustrated in the right-side flowchart of FIG. 1, “Yes” may be determined in both the determinations in Steps S2b and S5b, with the result that both of the processing depending on an event (Step S3b) and the task execution processing (Step S6b) may be executed.

The processor 2 calculates the utilization rate of the processor 2 based on the thus measured count values C1 and C2. For example, 1/C1 indicates time taken for execution of one processing loop in the idle state (referred to as “first execution time”). 1/C2 indicates time taken for execution of one processing loop in the execution state (referred to as “second execution time”). The processor 2 may calculate the utilization rate of the processor 2 by using the first and second execution times that are obtained from the count values C1 and C2.

For example, remaining time obtained through subtraction of the first execution time from the second execution time is considered as representing the execution time of processing that is not common between the processing loops in the idle state and the execution state. Thus, the remaining time highly possibly represents the execution time of processing that affects the effective utilization rate (busy rate) of the processor 2. Thus, the ratio of the remaining time to the second execution time is considered as representing the effective utilization rate of the processor 2.

Thus, the processor 2 may calculate the utilization rate of the processor 2 by Expression (1) below, for example.

$$Utilization rate [ \% ] = ( 1 \text{/} C 2 - 1 \text{/} C 1 ) \text{/} ( 1 \text{/} C 2 ) \times 100 = ( 1 - C 2 \text{/} C 1 ) \times 100 \qquad ( 1 )$$

As seen in the above-mentioned example, the information processing device 1 according to the first embodiment may measure the utilization rate of the processor 2 without using the execution time of an idle task. The information processing device 1 may measure the utilization rate of the processor 2 by, instead of directly measuring the execution time of the processing loop, counting the execution frequency of the processing loop, which is low-load processing as compared to processing time measurement.

### Second Embodiment

Next, there is described a storage system to which a storage control device is applied as an example of the information processing device 1 illustrated in FIG. 1.

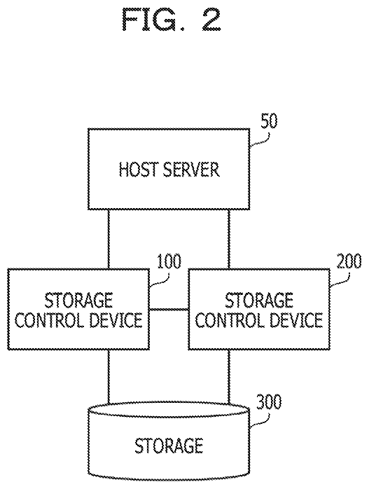

FIG. 2 is a diagram illustrating a configuration example of a storage system according to a second embodiment. As illustrated in FIG. 2, the storage system according to the second embodiment includes a host server 50, storage control devices 100 and 200, and a storage 300. The storage control devices 100 and 200 represent an example of the information processing device 1 illustrated in FIG. 1.

The host server 50 is, for example, a server computer configured to execute various processing such as work processing. The storage control devices 100 and 200 receive an input/output (I/O) requests from the host server 50 to process the requests. For example, one or more logical volumes to be accessed by the host server 50 are created with the use of the memory area of the storage 300. The storage control devices 100 and 200 each receive an I/O request corresponding to a logical volume from the host server 50, to thereby control the I/O processing on the logical volume. The storage control devices 100 and 200 are achieved as, for example, general-purpose server computers. In this case, the storage control devices 100 and 200 execute storage control by executing an application program for storage control. On the storage 300, one or more non-volatile memory devices are mounted. For example, on the storage 300, a solid state drive (SSD) is mounted as a non-volatile memory device.

The host server 50 and the storage control devices 100 and 200 are coupled to each other with the use of, for example, a fibre channel (FC) or an internet small computer system interface (iSCSI). The storage control devices 100 and 200 are coupled to each other with the use of, for example, an FC, an iSCSI, or a local area network (LAN). With the storage control devices 100 and 200 coupled to each other, for example, data distribution and data duplication (data copy from one device to another) may be achieved. The storage control devices 100 and 200 are coupled to the storage 300 with the use of, for example, an FC, an iSCSI, or serial advanced technology attachment (SATA).

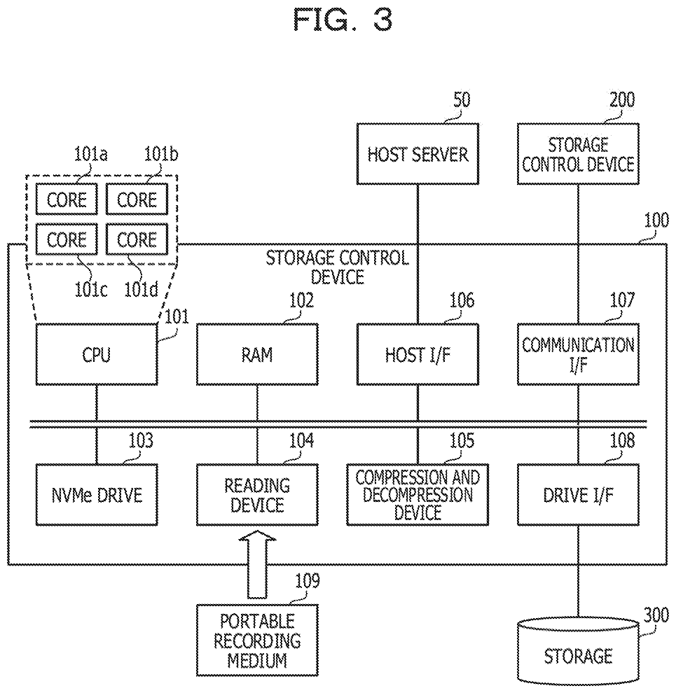

FIG. 3 is a diagram illustrating a hardware configuration example of a storage control device. FIG. 3 exemplifies the hardware configuration of the storage control device 100, but the storage control device 200 is achieved with a similar hardware configuration to the storage control device 100.

The storage control device 100 includes a CPU 101, a random access memory (RAM) 102, a non-volatile memory express (NVMe) drive 103, a reading device 104, a compression and decompression device 105, a host interface (I/F) 106, a communication interface (I/F) 107, and a drive interface (I/F) 108.

The CPU 101 is a processing device configured to read out programs from the RAM 102 to process the programs. The CPU 101 is a multicore CPU including a plurality of cores (processor cores). For example, as illustrated in FIG. 3, the CPU 101 includes cores 101a to 101d.

The RAM 102 is used as a main memory device of the storage control device 100. The RAM 102 temporarily stores at least part of an operating system (OS) program and an application program that is executed by the CPU 101. The RAM 102 stores various data required for processing by the CPU 101.

The NVMe drive 103 is an NVMe SSD and is used as, for example, a secondary cache for storage control. The NVMe drive 103 may be used as an auxiliary memory device of the storage control device 100. In this case, the NVMe drive 103 stores the OS program, the application program, and various data.

To the reading device 104, a portable recording medium 109 is removably mounted. The reading device 104 reads data recorded on the portable recording medium 109, and transmits the data to the CPU 101. Examples of the portable recording medium 109 include optical discs, magneto-optical discs, and semiconductor memories. The compression and decompression device 105 compresses data that is written to the storage 300. The compression and decompression device 105 decompresses compressed data read out of the storage 300.

The host interface 106 is an interface device for communication with the host server 50. The communication interface 107 is an interface device for communication with the other storage control device 200. The drive interface 108 is an interface device for communication with the non-volatile memory device included in the storage.

The cores 101a to 101d represent an example of the processor 2 illustrated in FIG. 1. The NVMe drive 103, the compression and decompression device 105, the host interface 106, the communication interface 107, and the drive interface 108 represent an example of the input/output device 3 illustrated in FIG. 1.

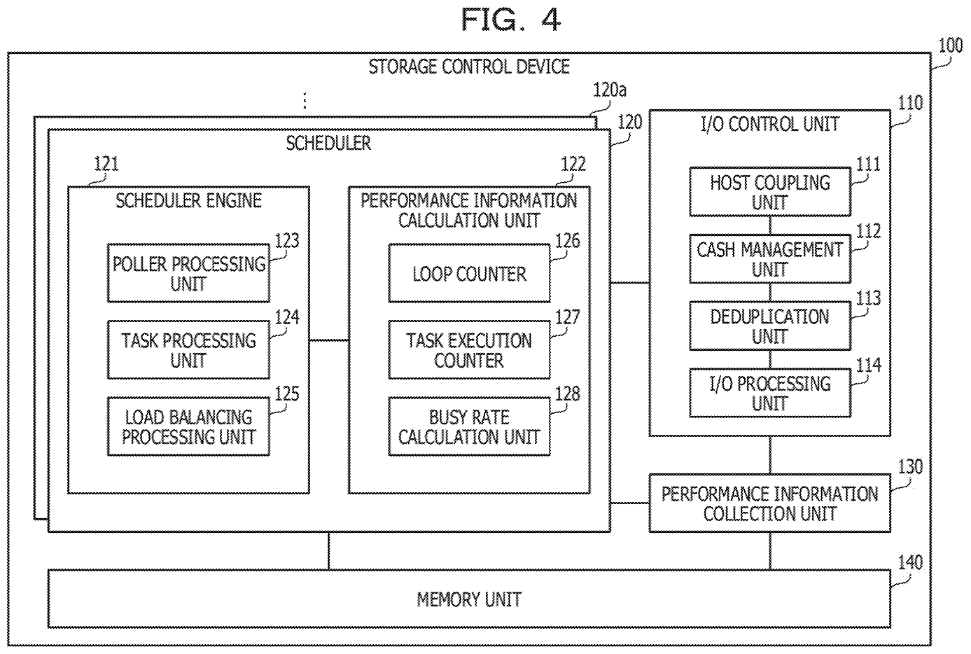

FIG. 4 is a block diagram illustrating a configuration example of a processing function of a storage control device. The storage control device 100 includes an I/O control unit 110, schedulers 120, 120a, etc., a performance information collection unit 130, and a memory unit 140. Processing by the I/O control unit 110, the schedulers 120, 120a, etc., and the performance information collection unit 130 is achieved by the CPU 101 executing a given program, for example. The memory unit 140 is achieved by, for example, the memory area of the RAM 102.

The I/O control unit 110 controls the I/O processing on logical volumes depending on I/O requests from the host server 50. The I/O control unit 110 includes, for example, a host coupling unit 111, a cash management unit 112, a deduplication unit 113, and an I/O processing unit 114.

The host coupling unit 111 receives I/O requests (write requests or read-out requests) from the host server 50. The cash management unit 112 controls, by using a cache memory area secured in the RAM 102, the I/O processing depending on I/O requests received by the host coupling unit 111. The deduplication unit 113 performs control for deduplicating data that is stored in the storage 300 depending on I/O requests. The I/O processing unit 114 writes deduplicated data compressed by the compression and decompression device 105 to the storage 300. Here, for example, writing is controlled by redundant arrays of inexpensive disks (RAID). The I/O processing unit 114 reads out data from the storage 300, and controls the compression and decompression device 105 to decompress the data.

The schedulers 120, 120a, etc. control execution of tasks that occur in each unit of the I/O control unit 110. Tasks in the I/O control unit 110 are substantively executed by the schedulers 120, 120a, etc. The schedulers 120, 120a, etc. control execution of processing depending on hardware events. The hardware events are, for example, events indicating completion of processing executed by the NVMe drive 103, the compression and decompression device 105, the host interface 106, the communication interface 107, and the drive interface 108.

Processing processes by the schedulers 120, 120a, etc. are executed by the respective individual cores in the CPU 101. For example, the processing by the scheduler 120 is executed by the core 101a and the processing by the scheduler 120a is executed by the core 101b. Since the schedulers 120, 120a, etc. have the same configuration, the scheduler 120 is now described as a representative. The scheduler 120 includes a scheduler engine 121 and a performance information calculation unit 122.

The scheduler engine 121 performs scheduling and execution control of tasks, hardware event detection, and execution control of processing depending on hardware events. In the present embodiment, a polling-based hardware event reception method using PMDs is used. In this method, occurred hardware events are detected by polling by pollers. The scheduler engine 121 starts pollers to repeatedly execute first processing including hardware event detection and processing depending on detected hardware events (hardware event processing) and second processing of executing scheduled tasks. In the following description, processing including the first processing and the second processing, which is repeatedly executed in this way, is referred to as “scheduler loop.”

The scheduler engine 121 includes a poller processing unit 123, a task processing unit 124, and a load balancing processing unit 125. The poller processing unit 123 executes processing by the pollers. The task processing unit 124 executes tasks. The load balancing processing unit 125 controls task execution so that a processing load is distributed between the cores (between the schedulers).

The performance information calculation unit 122 calculates, as one of performance information pieces, the busy rate of a corresponding core. For example, when the processing by the scheduler 120 is executed by the core 101a, the performance information calculation unit 122 of the scheduler 120 calculates the busy rate of the core 101a. The performance information calculation unit 122 includes a loop counter 126, a task execution counter 127, and a busy rate calculation unit 128. The loop counter 126 counts the frequencies of scheduler loops executed by the scheduler engine 121. The task execution counter 127 counts the frequencies of tasks executed by the task processing unit 124. The busy rate calculation unit 128 calculates busy rates by using scheduler loop execution frequencies and task execution frequencies.

The performance information collection unit 130 collects performance information on the storage control device 100. As the performance information, for example, the busy rates of the cores 101a to 101d, the usage of the RAM 102, and other matters are collected. As the busy rate, the busy rate of each core is collected from the performance information calculation unit 122 of each of the schedulers 120, 120a, etc.

The memory unit 140 stores data such as results of performance information calculation in the scheduler 120 and performance information collected by the performance information collection unit 130.

Next, task and hardware event processing is described.

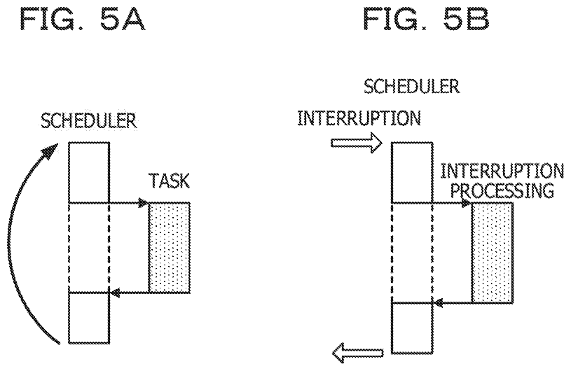

First, FIGS. 5A and 5B are diagrams illustrating a comparative example in terms of the task and hardware event processing. FIG. 5A illustrates normal processing for a case where no hardware event occurs. FIG. 5B illustrates a case where an interruption occurs.

A scheduler not using a PMD manages task execution and execution of hardware event processing depending on hardware events. For example, in a case where no hardware event occurs, as illustrated in FIG. 5A, the following processing is repeated: the scheduler discriminates an executable task and transfers control to the task in question (yields a CPU resource), and control is returned to the scheduler when execution of the task is ended. When a hardware event occurs, an interruption occurs as illustrated in FIG. 5B, and the scheduler interrupts execution control of the task and transfers control to the hardware event processing.

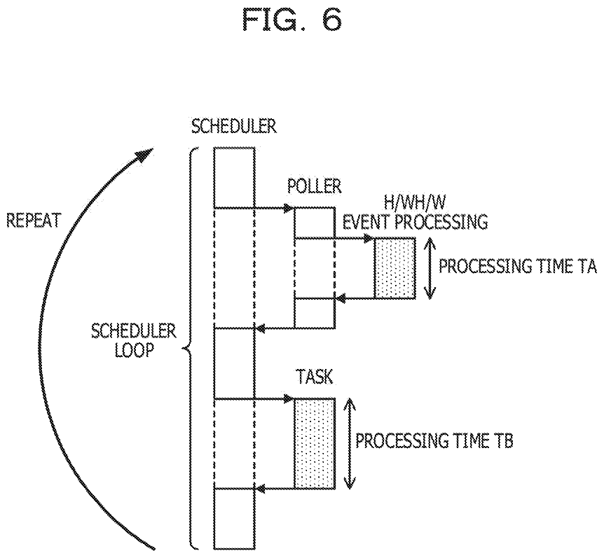

FIG. 6 is a diagram illustrating an example of the task and hardware event processing in a case where a PMD is used. In the present embodiment, the scheduler 120 (actually the scheduler engine 121) repeatedly executes the scheduler loop as illustrated in FIG. 6.

In the scheduler loop, first, the poller processing unit 123 of the scheduler 120 starts pollers, and the pollers perform polling for detecting hardware events. For example, a completion queue corresponding to hardware that issues a hardware event is prepared on the RAM 102, and when the hardware in question completes execution of certain processing, an entry indicating a hardware event that is completion of the processing is stored in the completion queue. A poller performs polling of the completion queue, and when acquiring the entry, transfers control to hardware event processing corresponding to the entry in question. The hardware event processing is executed as a result, and when the execution is completed, control is returned to the poller and control is returned to the poller processing unit 123 of the scheduler 120. Next, the task processing unit 124 of the scheduler 120 discriminates an executable task, and transfers control to the task in question. The task is executed as a result, and when the execution is completed, control is returned to the task processing unit 124 of the scheduler 120.

The hardware event processing is processing of making, for example, a task that is to receive a processing completion notification enter a state executable by the scheduler 120. As an example, there is described a case where data (for example, data requested by the host server 50 to be read out) is transmitted to the host server 50 through the host interface 106. An execution queue required for the scheduler 120 to acquire an executable task is prepared on the RAM 102.

For example, the host coupling unit 111 of the I/O control unit 110 stores an entry corresponding to a data transmission task in the execution queue. When acquiring the entry in question from the execution queue, the task processing unit 124 of the scheduler 120 executes, of processing processes included in the data transmission task, processing of requesting the host interface 106 to transmit the data to the host server 50. Then, the task processing unit 124 makes the data transmission task enter a suspend state.

After that, when the host interface 106 completes data transmission to the host server 50, a transmission completion message is stored in a given receive buffer, and an entry indicating transmission completion is stored in a completion queue. For example, a hardware event that is completion of data transmission by the host interface 106 occurs, and an entry corresponding to the event is stored in the completion queue. When a poller started by the poller processing unit 123 of the scheduler 120 acquires the entry from the completion queue, the hardware event processing corresponding to the entry is executed. In the hardware event processing, an entry indicating acquisition of the transmission completion message is stored in the execution queue. The entry includes identification information on the data transmission task and the address of the transmission completion message in the receive buffer. With such an entry stored in the execution queue, the data transmission task is activated.

Then, when acquiring the entry indicating acquisition of the transmission completion message from the execution queue, the task processing unit 124 of the scheduler 120 restarts execution of the data transmission task based on the entry. With the data transmission task executed, the transmission completion message is acquired from the receive buffer, with the result that the data transmission task is completed.

As the hardware event, for example, the following are also conceivable. For example, when a task for requesting the compression and decompression device 105 to compress data is executed in response to a request from the I/O processing unit 114, a hardware event that is completion of data compression by the compression and decompression device 105 occurs thereafter. Here, the compressed data is stored in the receive buffer. For example, when a task for requesting data writing or data reading with respect to the secondary cache of the NVMe drive 103 is executed in response to a request from the cash management unit 112, a hardware event that is completion of data writing or data reading by the NVMe drive 103 occurs thereafter. Here, a data writing completion message or the readout data is stored in the receive buffer.

As another example of the hardware event, there is processing that the host interface 106 performs to complete reception of I/O requests (write requests or read requests) from the host server 50. Alternatively, there is processing that the communication interface 107 performs to complete reception of messages (such as reception completion messages in response to data transmission or data reception messages in response to transmission requests) from the storage control device 200.

As described above, in the case where a PMD is used, every time the scheduler loop is executed, hardware event check by polling is performed without exception. Since no entry may exist in a completion queue in polling, polling for a case where no entry exists is useless. On the other hand, since neither interruptions nor context switches occur, hardware event detection and the hardware event processing are executable at a speed higher than that in the case where interruptions are used as illustrated in FIGS. 5A and 5B. Thus, in a case where data is frequently transferred between the CPU 101 and another hardware, such as storage control, since entries highly possibly exist in a completion queue in polling, hardware events may be efficiently processed.

In actuality, a poller and a completion queue are provided for each hardware device that is an event monitoring target. For example, when a scheduler loop is executed once, one of the pollers corresponding to the respective hardware devices is started and processing of detecting a hardware event of the hardware in question is executed. In this case, every time the scheduler loop is executed, a poller corresponding to another hardware is started. Alternatively, when the scheduler loop is executed once, the pollers corresponding to the respective hardware devices may be started sequentially.

Next, detection of core busy rates is described. In a computer such as the storage control device 100, CPU or core busy rates are utilized for various uses. For example, a busy rate is utilized to determine whether a cause of a drop in performance of a device is a CPU or core load. Alternatively, a busy rate is utilized to balance processing, which is executed by each core, to make the cores equally share the load. In the storage control device 100 of the present embodiment, a busy rate is utilized by the load balancing processing unit 125 to control task execution in the task processing unit 124 so that equal loads are applied to the cores 101a to 101d.

In a case where control as illustrated in FIGS. 5A and 5B is performed, when there is no task that a core is to execute, the core executes an idle thread (or an idle task) to use the processing cycle of the core. In this case, a busy rate may be calculated through measurement of time taken for execution of the idle thread and obtainment of the ratio of the execution time of the remaining processing.

On the other hand, in the case where a PMD is used as illustrated in FIG. 6, every time the scheduler loop is executed, polling by a poller is executed without exception. Due to such a configuration, in the case where a PMD is used, there is no counterpart to an idle thread in many cases. Thus, it is difficult to calculate a busy rate from the execution time of an idle thread.

Accordingly, the following method is conceivable: in scheduler loop execution time, time during which meaningful processing is executed (actual processing time) is measured, and the ratio of the time in question is calculated. The “meaningful processing” is mainly, in the case of the storage control device 100, processing that is executed in response to requests from the I/O control unit 110, and corresponds to the hardware event processing and the task processing in the example of FIG. 6. In this case, it is considered that a busy rate may be calculated through measurement of the execution time of one scheduler loop, the processing time of a hardware event (processing time TA in FIG. 6), and the execution time of a task (processing time TB in FIG. 6).

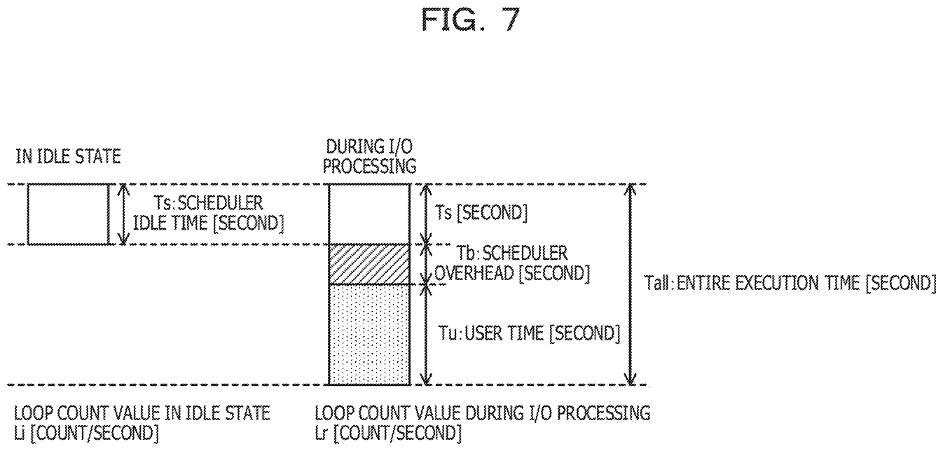

FIG. 7 is a diagram illustrating an example of a busy rate calculation method. First, a comparative example of the busy rate calculation method is described with reference to FIG. 7.

With regard to the processing times TA and TB illustrated in FIG. 6, it is difficult for a scheduler to directly continue the processing time TB of a hardware event, which is a problem. This is because after a scheduler has started a poller, it is difficult for the scheduler to grasp whether or not the poller has detected a hardware event (whether or not the hardware event processing has been executed). Thus, the actual processing time including the processing times TA and TB is difficult to directly measure.

Accordingly, in the comparative example, the actual processing time is estimated through estimation of processing time other than the actual processing time based on the execution time of one scheduler loop when the storage control device 100 is in the idle state in which the I/O control unit 110 does not start. For example, the execution time of one scheduler loop is measured when the storage control device 100 is in the idle state and when the I/O control unit 110 has started to start its processing and the I/O processing is thus being performed. As illustrated in FIG. 7, scheduler loop execution time measured in the idle state is referred to as “scheduler idle time Ts.” Meanwhile, scheduler loop execution time measured during the I/O processing is referred to as “entire execution time Tall.”

The I/O control unit 110 does not execute the processing in the idle state, and hence the scheduler idle time Ts does not include the actual processing time. Thus, it is estimated that time obtained through subtraction of the scheduler idle time Ts from the entire execution time Tall represents the actual processing time. However, the I/O processing includes, other than the hardware event processing and the task processing, processing that is not executed in the idle state. Such processing is, for example, load balancing processing for making the cores equally share a task processing load. As illustrated in FIG. 7, time that is taken for such processing is defined as “scheduler overhead Tb.” With such time taken into account, user time Tu that is obtained from Tall-Ts-Tb may be estimated as the actual processing time. In this case, a busy rate is calculated by Expression (2) below.

$$Busy rate = Tu \text{/} Tall \times 100 = ( Tall - Ts - Tb ) \text{/} Tall \times 100 \qquad ( 2 )$$

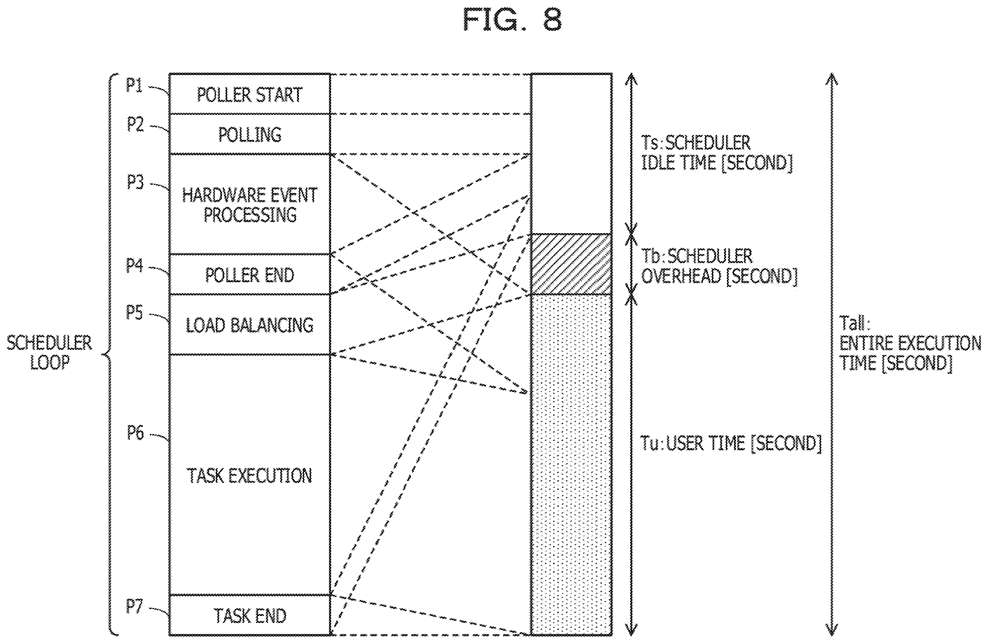

FIG. 8 is a diagram illustrating an example of processing included in a scheduler loop. With reference to FIG. 8, examples of processing processes that are executed in the scheduler idle time, the scheduler overhead, and the user time are described.

The scheduler loop during the I/O processing includes, for example, processing P1 for poller start, processing P2 for polling, processing P3 for the hardware event processing, processing P4 for poller end, processing P5 for load balancing related to task execution, processing P6 for task execution, and processing P7 for task end.

The scheduler idle time Ts includes the time of processing that is executed during the I/O processing and in the idle state. In the example of FIG. 8, the scheduler idle time Ts includes the times of the processing processes P1, P2, P4, and P7. The user time Tu includes the times of the processing processes P3 and P6. The processing P5 is processing of determining whether to execute a task from a load balance state between the cores. Since the processing P5 is not executed in the idle state in which there is no task to be executed, the scheduler overhead Tb includes the time of the processing P5. Thus, the user time Tu may be calculated from Tall-Ts-Tb through measurement of the scheduler idle time Ts in the idle state and measurement of the entire execution time Tall during the I/O processing.

Incidentally, in the comparative example described above, processing time measurement may be required for each scheduler loop. Thus, a processing load for processing time measurement is large, with the result that the processing performance of the CPU 101, for example, the processing performance of the I/O control unit 110 drops, which is a problem. Accordingly, the storage control device 100 of the present embodiment calculates busy rates by counting scheduler loop execution frequencies instead of measuring processing time.

As illustrated in FIG. 7, in the present embodiment, the loop counter 126 of the performance information calculation unit 122 counts a scheduler loop execution frequency (the number of loops) per unit time in the idle state and during the I/O processing. A loop count value that is counted per unit time in the idle state is denoted by Li, and a loop count value that is counted per unit time during the I/O processing is denoted by Lr. The unit time is one second as an example.

The average value of the scheduler idle times Ts per unit time is obtained from Ts=1/Li with the use of the loop count value Li per unit time in the idle state. The average value of the entire execution times Tall of the scheduler loops per unit time during the I/O processing is obtained from Tall=1/Lr with the use of the loop count value Lr per unit time during the I/O processing.

The scheduler overhead Tb is a required cost that increases depending on the number of tasks that are executed during the I/O processing, and may extremely small compared to the user time Tu. Thus, the scheduler overhead Tb may be included in the user time Tu as a required cost that occurs for task execution. In this case, the busy rate calculation unit 128 may approximately calculate a busy rate by Expression (3) below.

$$Busy rate [ \% ] = ( Tall - Ts ) \text{/} Tall = ( 1 \text{/} Lr - 1 \text{/} Li ) \text{/} ( 1 \text{/} Lr ) \times 100 = ( 1 - Lr \text{/} L i ) \times 100 \qquad ( 3 )$$

Through the processing above, even in a system in which there is no idle thread, CPU or core busy rates may be calculated. With Expression (3), since not the execution time of processing but the execution frequency thereof is measured, a busy rate may be measured with a low processing load.

Incidentally, core busy rates are used for determining whether the cores have remaining power, and are thus desirably indicators indicating 100% when the cores reach their performance limits. However, in Expression (2) above, the scheduler idle time Ts and the scheduler overhead Tb do not take zero even when the performance limit is reached, and hence the maximum value of a calculated busy rate does not reach 100%. Thus, it is desirable that the scheduler idle time Ts and the scheduler overhead Tb when the performance limit is reached be predicted, and a busy rate be corrected based on the prediction.

It is conceivable that when the performance limit is almost reached, since tasks are executed in almost all the scheduler loops, the task processing time (the processing time TB in FIG. 6) occupies large part of the user time Tu. Accordingly, the busy rate calculation unit 128 corrects the busy rate calculated by Expression (3) based on a predicted number of loops (a loop count value Lb described later) in a case where tasks are executed in almost all the scheduler loops.

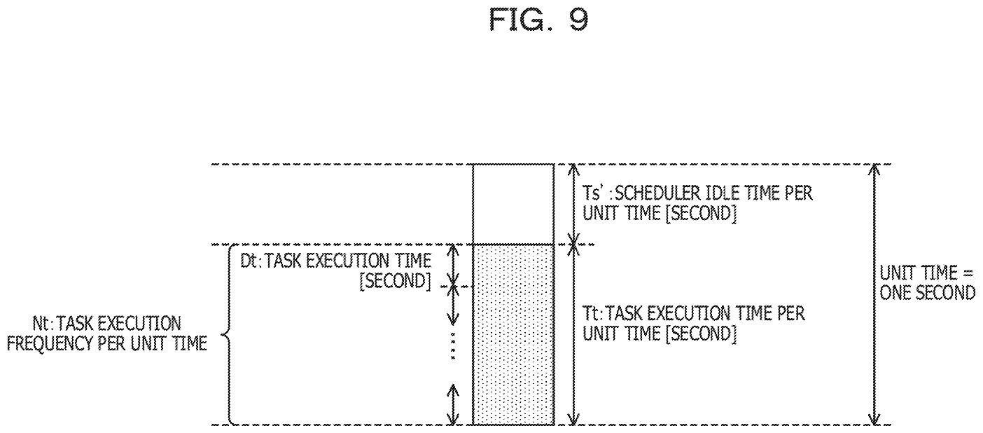

FIG. 9 is a diagram illustrating processing time allocation per unit time when a performance limit is reached.

The task execution counter 127 of the performance information calculation unit 122 counts, during the I/O processing, a task execution frequency Nt by the task processing unit 124 per unit time. A scheduler idle time Ts' per unit time is calculated by Expression (4) below based on a count value obtained by the loop counter 126.

Ts′=1/Ts=Lr/Li (4)

Similar to the above, the scheduler overhead Tb is considered to be included in the user time Tu as a required cost. It is considered that when the performance limit is reached, tasks are executed in all the scheduler loops per unit time, and the task execution time occupies most part of the user time Tu. A task execution time Tt per unit time when the performance limit is reached is calculated by Expression (5) below. A task execution time Dt representing average task execution time when the performance limit is reached is calculated by Expression (6) below.

Tt=1−Ts′=1−Lr/Li (5)

Dt=Tt/Nt (6)

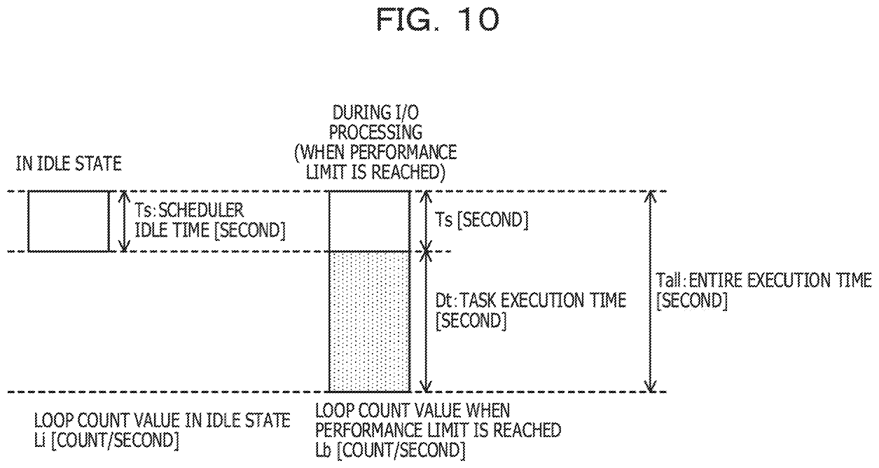

FIG. 10 is a diagram illustrating processing time allocation in execution time of one scheduler loop.

The task execution time Dt calculated by Expression (6) above may be considered to represent the user time Tu when the performance limit is reached. In this case, as illustrated in FIG. 10, Expression (7) below is satisfied when the performance limit is reached.

Tall=Dt+Ts (7)

The loop count value Lb per unit time when the performance limit is reached is calculated by Expression (8) below.

Lb=1/Tall=1/(Dt+Ts) (8)

Thus, a core busy rate when the performance limit is reached is calculated by Expression (9) below. Expression (9) is obtained by assigning Lb to Lr in Expression (3).

$$Busy rate = ( Tall - Ts ) \text{/} Tall = ( 1 - Lb \text{/} L i ) \times 100 \qquad ( 9 )$$

The value calculated by Expression (9) represents a value when the performance limit is reached, for example, a value when a real busy rate is 100%. Thus, with the calculated value in Expression (9) regarded as 100%, a correction value a is obtained based on Expression (9). The correction value a is used for correcting the calculated value in Expression (3) so that the maximum value of the calculated value in question takes 100%. The correction value a is calculated by Expression (10) below.

α=1/(1−Lb/Li) (10)

From the above, the busy rate calculation unit 128 calculates a busy rate corrected so that the maximum value takes 100% by Expression (11) below by using the loop count values Li and Lr from the loop counter 126 and the task execution frequency Nt from the task execution counter 127.

$$Busy rate = ( 1 - Lr \text{/} Li ) \times a \times 100 = ( 1 - Lr \text{/} Li ) \text{/} ( 1 - Lb \text{/} L i ) \times 100 \qquad ( 11 )$$

Expression (11) is an equation in which the calculated value in Expression (3) is corrected by the correction value a. With the use of Expression (11), the storage control device 100 may accurately calculate a core busy rate by counting a scheduler loop execution frequency and a task execution frequency, which is low load processing.

Next, processing by the storage control device 100 is described with the use of a flowchart.

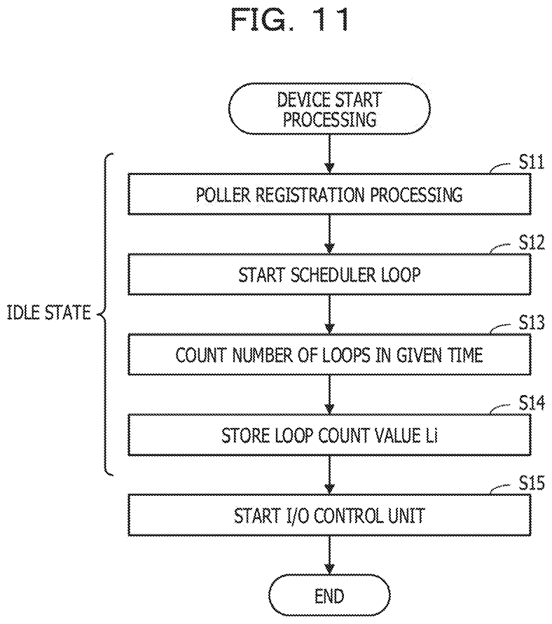

First, FIG. 11 is a flowchart illustrating an example of processing by a storage control device after the storage control device has started (device start processing). The processing of FIG. 11 is executed in a state where the storage control device 100 has started and the scheduler 120 has started (in the idle state described above). Here, the I/O control unit 110 does not start, and the I/O processing is thus not executed.

[Step S11] When the scheduler 120 starts, the scheduler engine 121 registers pollers to be used. For example, the scheduler engine 121 searches for coupled hardware and registers pollers corresponding to the respective hardware devices searched.

[Step S12] The scheduler engine 121 starts a scheduler loop. In this stage, since the storage control device 100 is in the idle state in which the I/O control unit 110 does not start, tasks that the scheduler 120 may execute do not occur, and no hardware event is detected by the pollers.

[Step S13] The loop counter 126 counts a scheduler loop execution frequency (the number of loops) in a given time. For example, the number of loops per unit time (one second) is counted. Alternatively, the number of loops in a given time longer than the unit time is counted.

[Step S14] The loop counter 126 calculates, based on the count number in Step S13, the loop count value Li per unit time in the idle state, and stores the loop count value Li in the memory unit 140. In a case where the number of loops per unit time is counted in Step S13, the number of loops in question is directly stored in the memory unit 140 as the loop count value Li. In a case where the number of loops in the time longer than the unit time is counted in Step S13, the average number of loops per unit time based on the number of loops in question is calculated, and the calculated average number of loops is stored in the memory unit 140 as the loop count value Li.

[Step S15] When storage of the loop count value Li with respect to each of the cores 101a to 101d is completed, the I/O control unit 110 starts. The idle state is thus ended, and the I/O processing is started. In the scheduler loop, tasks that the scheduler 120 may execute now occur, and hardware events are detected by the pollers.

The loop count value Li may be calculated in one of the cores 101a to 101d, and the value in question may be used in common by the cores 101a to 101d.

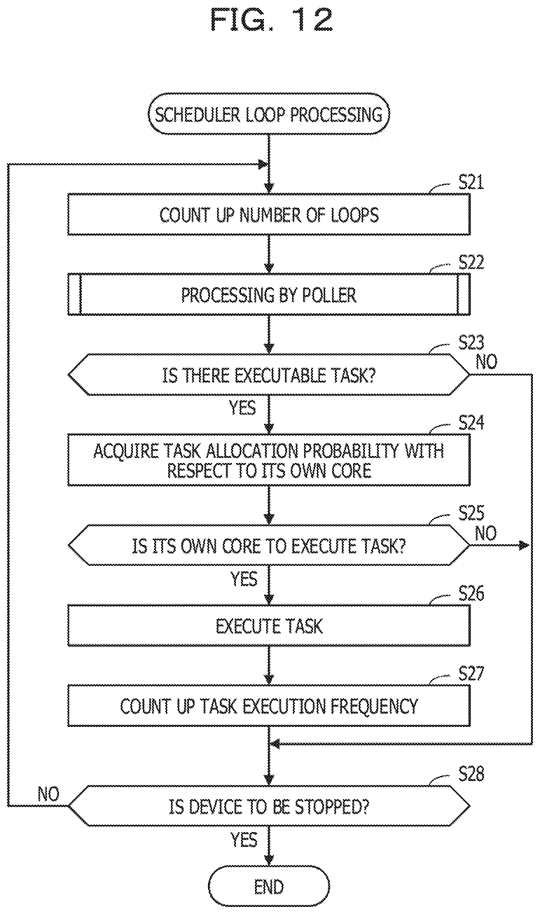

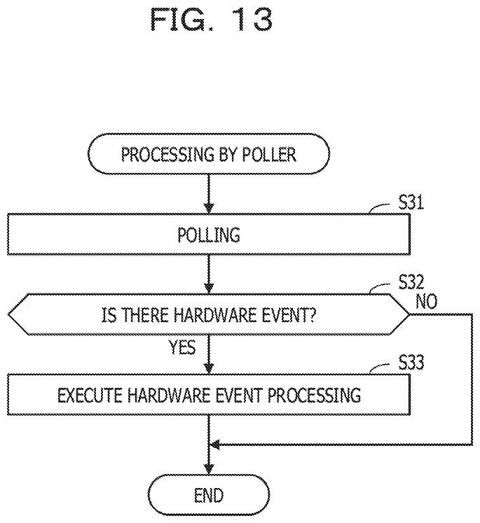

FIG. 12 is a flowchart illustrating an example of scheduler loop processing. Processing in Steps S21 to S27 in FIG. 12 corresponds to processing in one scheduler loop. The processing in FIG. 12 is executed in the idle state and during the I/O processing.

[Step S21] The loop counter 126 counts up the number of loops representing a scheduler loop execution frequency.

[Step S22] The poller processing unit 123 starts a poller. With this, the poller performs polling of a completion queue. When a hardware event is detected by polling, for example, when an entry is acquired from the completion queue, the hardware event processing is executed. Processing by the poller is described later with reference to FIG. 13.

[Step S23] The task processing unit 124 determines whether there is an executable task. When there is an executable task, the processing proceeds to Step S24. When there is no executable task, the processing proceeds to Step S28. In the idle state, there is no executable task, and the processing thus proceeds to Step S28.

[Step S24] The load balancing processing unit 125 acquires a task allocation probability with respect to its own core (here the core 101a that is executing the processing of the scheduler 120).

[Step S25] The load balancing processing unit 125 determines, based on the task allocation probability, whether its own core is to execute the task. When it is determined that the core in question is to execute the task, the processing proceeds to Step S26. When it is determined that the core in question is not to execute the task, the processing proceeds to Step S28.

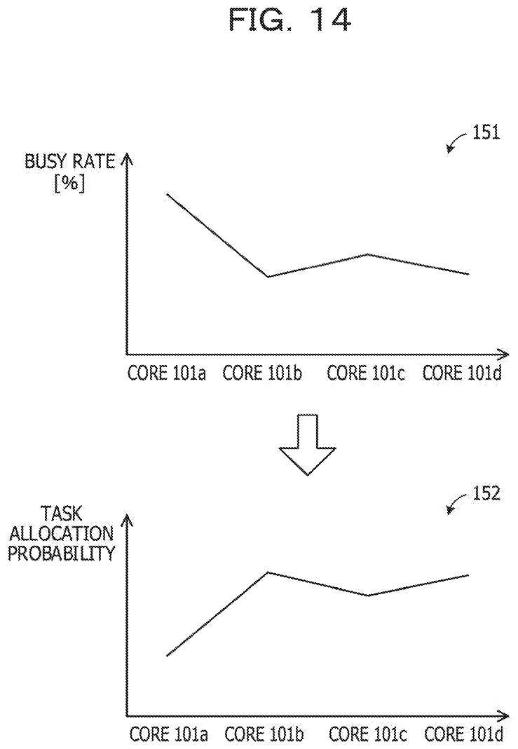

A processing example of load balancing is described in detail later with reference to FIG. 14.

[Step S26] The task processing unit 124 executes the task.

[Step S27] The task execution counter 127 counts up a count number representing a task execution frequency.

[Step S28] The scheduler engine 121 determines whether the storage control device 100 is to be stopped. When the storage control device 100 continues to operate, the processing proceeds to Step S21. When the storage control device 100 is to be stopped, the processing is ended.

FIG. 13 is a flowchart illustrating an example of processing by a poller.

[Step S31] A poller started by the poller processing unit 123 performs polling of a completion queue corresponding to the poller in question.

[Step S32] The poller determines whether there is a hardware event. When an entry has been acquired from the completion queue by polling, it is determined that there is a hardware event. When there is a hardware event, the poller executes processing in Step S33. When there is no hardware event, the processing is ended.

[Step S33] The poller executes the hardware event processing based on the entry acquired from the completion queue.

In Step S22 in FIG. 12, for example, a poller is started for each hardware device that is an event detection target, and each started poller executes the processing in FIG. 13. Alternatively, for each scheduler loop execution, one of pollers corresponding to the respective hardware devices may be selected in order, and a selected poller may execute the processing in FIG. 13.

FIG. 14 is a diagram illustrating load balancing. The task allocation probability that is acquired in Step S24 in FIG. 12 is calculated as follows, for example.

The load balancing processing unit 125 collects the calculated busy rates of the cores 101a to 101d. As indicated by the graph 151 in FIG. 14, the busy rates of the cores 101a to 101d are different from each other in some cases. The load balancing processing unit 125 calculates task allocation probabilities of the respective cores 101a to 101d that reduce the difference in busy rate between the cores 101a to 101d, as indicated by the graph 152. In Step S24 in FIG. 12, a task allocation probability calculated with respect to the core 101a in this way is acquired.

For example, when task allocation probabilities are newly calculated, control is performed so that tasks that occur in a certain period after the calculation are allocated to the cores 101a to 101d to be executed at a ratio depending on the task allocation probabilities. In this case, in Step S25 in FIG. 12, control for determining whether to execute a task in a current scheduler loop is performed so that the frequency of task execution by the task processing unit 124 in the certain period takes a value depending on the task allocation probability. As another example, the cores 101a to 101d may individually acquire the busy rates of the respective cores 101a to 101d in Step S24, and calculate task allocation probabilities with respect to their own cores.

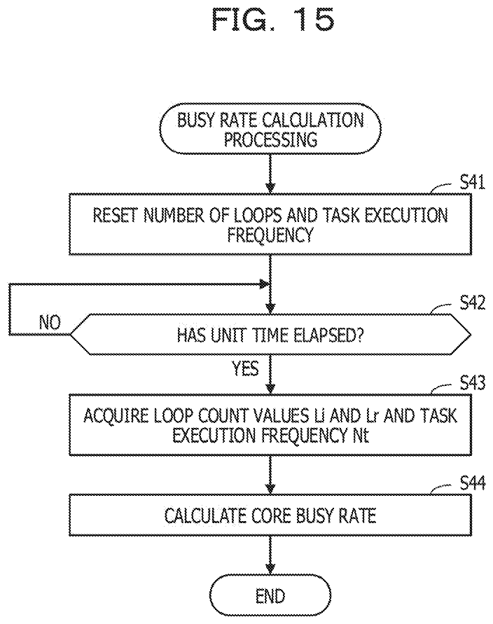

FIG. 15 is a flowchart illustrating an example of busy rate calculation processing.

[Step S41] The busy rate calculation unit 128 resets a loop count value obtained by the loop counter 126 and a task execution count value obtained by the task execution counter 127 to zero.

[Step S42] The busy rate calculation unit 128 waits until the unit time (one second) has elapsed. When the unit time has elapsed, the busy rate calculation unit 128 executes processing in Step S43.

[Step S43] The busy rate calculation unit 128 acquires the loop count value Li that is an idle value from the memory unit 140. The busy rate calculation unit 128 also acquires, as the loop count value Lr during the I/O processing, a loop count value obtained by the loop counter 126. In addition, the busy rate calculation unit 128 acquires, as the task execution frequency Nt, a task execution count value obtained by the task execution counter 127.

[Step S44] The busy rate calculation unit 128 applies the values acquired in Step S43 to Expression (11) above to calculate the busy rate of the core 101a.

According to the processing described above, the storage control device 100 may calculate core busy rates while performing storage control using a PMD in which there is no idle thread. The storage control device 100 may accurately calculate core busy rates by counting scheduler loop execution frequencies and task execution frequencies, which is low-load processing.

The processing functions of the devices of each embodiment (for example, the information processing device 1 and the storage control devices 100 and 200) described above may be achieved by a computer. In this case, a program having described therein the processing details of the function that each device is to have is provided. With the program being executed by the computer, the above-mentioned processing functions are achieved on the computer. The program having the processing details described therein may be recorded on a computer-readable recording medium. Examples of the computer-readable recording media include magnetic memory devices, optical discs, magneto-optical recording media, and semiconductor memories. Examples of the magnetic memory devices include hard disk devices (HDDs) and magnetic tapes. Examples of the optical discs include compact discs (CDs), digital versatile discs (DVDs), and Blu-ray discs (BDs, registered trademark).

Examples of the magneto-optical recording media include magneto-optical disks (MOs).

To distribute the program, for example, portable recording media, such as DVDs or CDs, having the program recorded thereon are sold. Alternatively, the program may be stored in a memory device of a server computer, and the program may be transferred from the server computer to another computer via a network.

The computer configured to execute the program stores, in its own memory device, the program recorded on the portable recording medium or the program transferred from the server computer, for example. Then, the computer reads the program from its own memory device to execute processing based on the program. The computer may directly read the program from the portable recording medium to execute the processing based on the program. The computer may execute, every time the program is transferred from the server computer, which is coupled thereto via the network, the processing based on the received program.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing device, comprising:
a processor; and
an input/output device configured to input/output data from/to the processor, wherein
the processor is configured to
repeatedly execute a processing loop including execution control processing of checking an event from the input/output device, and when an event is detected, executing processing depending on the event detected,
measure, when the information processing device is in an idle state, a first count value indicating an execution frequency of the processing loop per unit time,
measure, when the information processing device is in an execution state in which the information processing device executes given processing including input/output processing with the input/output device, a second count value indicating the execution frequency of the processing loop per the unit time, and
calculate, based on the first count value and the second count value, an indicator indicating a utilization rate of the processor.

2. The information processing device according to claim 1, wherein
the indicator is calculated based on a difference between execution time of the processing loop that is calculated from the first count value and execution time of the processing loop that is calculated from the second count value.

3. The information processing device according to claim 1, wherein
the processing loop further includes task control processing of checking a task that occurs when the given processing is executed, and when an executable task is detected, executing the task detected,
the processor further measures, in the execution state, a third count value indicating an execution frequency of a task in the task control processing per the unit time, and
in calculation of the indicator, a first indicator indicating the utilization rate of the processor is calculated based on the first count value and the second count value, and a second indicator is calculated through correction of the first indicator using the third count value so that the first indicator takes a maximum value of 100%.

4. The information processing device according to claim 3, wherein
in calculation of the indicator,
the first indicator is calculated based on a difference between execution time of the processing loop that is calculated from the first count value and execution time of the processing loop that is calculated from the second count value,
a fourth count value is calculated based on the third count value and the first count value, the fourth count value indicating the execution frequency of the processing loop per the unit time when the utilization rate of the processor is 100%, and
the second indicator is calculated through correction of the first indicator so that a third indicator indicating the utilization rate of the processor matches the first indicator, the third indicator being calculated based on a difference between the execution time of the processing loop that is calculated from the first count value and execution time of the processing loop that is calculated from the fourth count value.

5. The information processing device according to claim 1, wherein
the information processing device includes a storage control device configured to control access to a memory device, and
the given processing includes access control processing on the memory device that is executed when the input/output device receives input or output.

6. A non-transitory computer-readable storage medium storing a program that causes a processor included in a computer to execute a process, the process comprising:
repeatedly executing a processing loop including execution control processing of checking an event from an input/output device configured to input/output data from/to the processor, and when an event is detected, executing processing depending on the event detected;
measuring, when the computer is in an idle state, a first count value indicating an execution frequency of the processing loop per unit time;
measuring, when the computer is in an execution state in which the computer executes given processing including input/output processing with the input/output device, a second count value indicating the execution frequency of the processing loop per the unit time; and
calculating, based on the first count value and the second count value, an indicator indicating a utilization rate of the processor.

7. The storage medium according to claim 6, wherein
the indicator is calculated based on a difference between execution time of the processing loop that is calculated from the first count value and execution time of the processing loop that is calculated from the second count value.

8. The storage medium according to claim 6, wherein
the processing loop further includes task control processing of checking a task that occurs when the given processing is executed, and when an executable task is detected, executing the task detected,
the processor is further caused to execute a process of measuring, in the execution state, a third count value indicating an execution frequency of a task in the task control processing per the unit time, and
in calculation of the indicator, a first indicator indicating the utilization rate of the processor is calculated based on the first count value and the second count value, and a second indicator is calculated through correction of the first indicator using the third count value so that the first indicator takes a maximum value of 100%.

9. The storage medium according to claim 8, wherein
in calculation of the indicator,
the first indicator is calculated based on a difference between execution time of the processing loop that is calculated from the first count value and execution time of the processing loop that is calculated from the second count value,
a fourth count value is calculated based on the third count value and the first count value, the fourth count value indicating the execution frequency of the processing loop per the unit time when the utilization rate of the processor is 100%, and
the second indicator is calculated through correction of the first indicator so that a third indicator indicating the utilization rate of the processor matches the first indicator, the third indicator being calculated based on a difference between the execution time of the processing loop that is calculated from the first count value and execution time of the processing loop that is calculated from the fourth count value.
